(19) United States
(12) Patent Application Publication
(10) Pub. No.: US 2026/0267358 A1
(43) Pub. Date: Sep. 10, 2026

(54) Fault Management for Unmanned Aerial Vehicles

(71) Applicant: Zipline International Inc., South San Francisco, CA (US)

(72) Inventors: Ryan OKSENHORN, San Francisco, CA (US); Blake Devin RICHARDS, Sandy, UT (US)

(21) Appl. No.: 19/016,274

(22) Filed: Jan. 10, 2025

Related U.S. Application Data
(60) Provisional application No. 63/567,505, filed on Mar. 20, 2024.

(51) Int. Cl. G05D 1/86; G05D 1/617; G05D 1/69; G05D 109/25

(52) U.S. Cl. CPC G05D 1/86; G05D 1/617; G05D 1/69; G05D 2109/254

(57) ABSTRACT

Fault management for unmanned aerial vehicles (UAVs) is disclosed. In one example, a method of managing a UAV includes receiving one or more fault signals from one or more systems of the UAV. The method may include determining a capability combination (e.g., a combination of failed capabilities) of the UAV based on the one or more fault signals. The method may include determining or adjusting a system level response of the UAV based on the capability combination (e.g., based on the failed capabilities). In one example, a method of managing a UAV includes determining a compromised capability of the UAV based on a received fault signal, and determining a system level response of the UAV based on the compromised capability.

### CROSS-REFERENCE TO RELATED APPLICATIONS

This application claims priority to U.S. Provisional Application No. 63/567,505, filed Mar. 20, 2024, and titled “FAULT MANAGEMENT FOR UNMANNED AERIAL VEHICLES,” which is incorporated herein by reference in its entirety, for any purpose.

### FIELD

The described embodiments relate generally to an unmanned aerial vehicle (UAV), such as one that may be used to deliver payloads (e.g., packages).

### BACKGROUND

Aerial vehicles, such as airplanes and unmanned vehicles (e.g. drones, UAVs, etc.), have many uses. Recently, aerial vehicles are becoming a viable option for package delivery vehicles. Such aerial vehicles can take many forms, such as, but not limited to, rotorcraft (e.g., helicopters, quadrotors, and so on) as well as fixed-wing aircraft. During delivery, all or portion of the flight commands to the aerial vehicle may be autonomously generated or executed.

However, anomalies may occur during flight or at pickup or delivery locations for a package.

As aerial vehicles are used more frequently for package deliveries, there is a need for improved overall systems that allow reliable delivery of a package to a delivery location. Further, there is a need for a system that provide an ability to safely carry a diverse array of goods in a wide range of environments to precise locations using autonomous delivery systems that create a smooth and pleasant delivery experience for a recipient.

### SUMMARY

In one example, a method of managing a UAV is disclosed. The method may include receiving one or more fault signals form one or more systems of the UAV. The method may include determining a capability combination of the UAV based on the one or more fault signals. The method may include determining a system level response of the UAV based on the capability combination.

In examples, the method may include adjusting a flight of the UAV based on the system level response. The capability combination may include a combination of one or more of the following capabilities of the UAV: reaching a dock, reaching a predetermined site, paralanding, hovering in place, and performing a docking maneuver. The determining the capability combination may include querying a capability response matrix, the capability response matrix indicating available and failed capabilities of the UAV. The determining the system level response may include analyzing the capability combination based on a mission characteristic of the UAV. The mission characteristic may include at least one of environmental data, geographic data, or payload data. The method may include generating an alarm based on the capability combination. The UAV may include a first UAV and a second UAV. The method may include adjusting a system operation of the second UAV based on the system level response of the first UAV.

In one example, a method of managing a UAV is disclosed. The method may include determining a compromised capability of the UAV based on a received fault signal. The method may include determining a system level response of the UAV based on the compromised capability.

In examples, the method may include querying a capability response matrix, the capability response matrix providing the system level response based on the compromised capability. The compromised capability may be a first compromised capability and the system level response may be a first system level response. The method may include determining a second compromised capability of the UAV based on a received second fault signal. The method may include determining a second system level response of the UAV based on the combination of the first compromised capability and the second compromised capability. The second system level response may be different than the first system level response. The method may include querying a capability response matrix, the capability response matrix providing the second system level response based on the combination of the first compromised capability and the second compromised capability. The method may include determining a third compromised capability of the UAV based on a received third fault signal. The method may include determining a third system level response of the UAV based on the combination of the first compromised capability, the second compromised capability, and the third compromised capability. The third system level response may be different than the first system level response and the second system level response. The method may include querying a capability response matrix, the capability response matrix providing the third system level response based on the combination of the first compromised capability, the second compromised capability, and the third compromised capability.

In one example, a method of managing a UAV is disclosed. The method may include receiving one or more fault signals from one or more systems of the UAV. The method may include determining a combination of failed capabilities of the UAV based on the one or more fault signals. The method may include adjusting a system level response of the UAV based on the combination of failed capabilities.

In examples, the method may include determining one or more functional failures of the one or more systems based on the one or more fault signals, the one or more functional failures associated with at least one failed capability of the UAV. The method may include generating an alarm based on the one or more functional failures. The adjusting the system level response may include prioritizing a first system level response over a second system level response based on respective costs of the first system level response and the second system level response. The respective costs may include safety costs, such as air risk, ground risk, and any safety cost associated with not completing a mission. The respective costs may include UAV costs, recovery costs, and property damage costs. The method may include generating an alarm based on a failed capability of the UAV.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an example UAV.

FIG. 2 illustrates an example UAV including a first aerial vehicle and a second aerial vehicle deployed from the first aerial vehicle.

FIG. 3 illustrates an example docking assembly for a UAV.

FIG. 4 illustrates a schematic diagram of an example aerial vehicle system.

FIG. 5 illustrates a diagram of determining a functional failure of a UAV.

FIG. 6 illustrates a diagram of determining a system level response of a UAV based on a combination of failed UAV capabilities.

FIG. 7 illustrates a diagram of a capability response matrix.

FIG. 8 illustrates a diagram of determining a system level response of a UAV based on a capability response matrix.

FIG. 9 illustrates a flow chart for an example method of managing a UAV.

FIG. 10 illustrates a flow chart for another example method of managing a UAV.

FIG. 11 illustrates a flow chart for another example method of managing a UAV.

FIG. 12 illustrates a schematic diagram of an example computer system for implementing various embodiments in the examples described herein.

### DETAILED DESCRIPTION

The description that follows includes sample systems, methods, and apparatuses that embody various elements of the present disclosure. However, it should be understood that the described disclosure may be practiced in a variety of forms in addition to those described herein.

The examples described herein are generally directed to methods and systems that enable fault management of UAVs. The examples disclosed herein facilitate operation of UAVs when anomalies are predicted or occur. For example, upon detection of an anomaly, a system level response may be driven based on available capabilities. System level responses may include navigating to a dock or a predetermined site, landing, or “paralanding,” among other responses. “Paralanding” or “paraland” may refer to landing using a parachute, such as for emergency or other flight anomaly landing situations. In some examples, “paralanding” or “paraland” may refer to emergency (or other anomaly) landing protocols generally, such as landing without power or other flight anomaly, whether by parachute, gliding, or other means.

The fault detection systems described herein may be implemented within UAVs or systems utilizing UAVs (e.g., an aerial system). The UAVs may be utilized in a delivery system configured to pick up a payload or a package at a shipping location and deliver a payload or package to a delivery location. It should be noted that while various features and components are discussed with respect to UAVs or UAV systems, the features and components can be used separately from the UAV and/or in various combinations with each other. As such the discussion of any particular implementation is meant as illustrative only.

An example aerial system is disclosed that may include a first aerial vehicle (e.g., a main or carrier aerial vehicle) and a second aerial vehicle (e.g., a dependent aerial vehicle). In these instances, the first aerial vehicle may act to support and/or transport the second aerial vehicle to a location and the second aerial vehicle can be deployed from the first aerial vehicle, e.g., the second aerial vehicle can be deployed from a first height and descend to a second height or location, such as to deliver a package. In some embodiments, the first aerial vehicle may be able to remain at a high location, such as by hovering, and may reduce the noise, disruption, and safety risks experienced by humans and animals on the ground or delivery location as the second vehicle may be quieter than the first aerial vehicle. In some examples, the first aerial vehicle can be optimized for longer flight paths and the second aerial vehicle can be optimized for an enhanced delivery experience to a human on the ground or delivery location. The payload may be a good or package including consumer goods, food, medical supplies, or other items. Additional variations of the first aerial vehicle and/or the second aerial vehicle may include types of rotorcraft (e.g., helicopters, quadrotors, and so on) or similar vehicles that generate thrust for movement through air, as well as fixed-wing aerial vehicles.

The locations may include a retail, wholesale, industrial, mail carrier, or other site in which payloads and packages are processed for delivery to a customer. The delivery location may include a package location designated as a specific portion of a building or area, such as a door, a window, a deck, a roof, a parking area, or other locations accessible by a delivery recipient.

The first aerial vehicle may include flight assemblies enabling different types of flight. For example, the first aerial vehicle may include fixed wings and a cruise propeller configured to forward or cruise flight motion and may also include one or more propeller assemblies configured for hover or similar motion. The cruise propeller may be articulable (e.g. rotatable) between a cruise flight and hover flight position.

In many embodiments, the second aerial vehicle may be coupled to the first aerial vehicle, e.g., by a tether, cable, or the like. In some embodiments, the second aerial vehicle may be stowed within a portion of the first aerial vehicle, such as a cavity or bay, for a first portion of the mission and deployed and retracted for a second portion of the mission.

The second aerial vehicle may have separate drive abilities, allowing the second aerial vehicle to steer itself without or to supplement steering by the first aerial vehicle. For example, the second aerial vehicle may include a propulsion assembly allowing the second aerial vehicle to move relative to the first aerial vehicle. The propulsion assembly may include thrusters to provide active control or enable generation of thrust irrespective of the position of the second aerial vehicle.

The body of the second aerial vehicle may include a volume or feature to house the payload, e.g., a payload bay. In some examples, the payload bay may be accessible through one or more apertures by one or more selectively openable assemblies, such as a lid or doors, to place a payload in the bay or to remove the payload from the bay at the delivery location.

The aerial vehicles may include one or more sensors that collect data to assist in the operation of the aerial vehicle. For example, the aerial vehicles may include a plurality of sensor assemblies such as audio or sound sensors, visual sensors such as cameras, or the like. The various sensors may be used in combination with processing elements or other systems to navigate. For example, the aerial vehicle may be operated remotely or completely autonomously. The sensors may detect information regarding the environment, such as obstacles, weather information, and the like, and may include a computer and/or be in communication with a processor, to allow the aerial vehicles to make decisions regarding flight, docking, and landing.

The various computers or processors in communication with the sensors may be associated with machine learned models, databases, or the like to assist in categorizing or understanding sensed information. For example, a machine learned model may be trained to identify objects in images captured by the sensors and the various computing elements may identify flight paths or maneuvers based on the identified objects, or positions of the objects relative to the aerial vehicles. The first aerial vehicle and second aerial vehicle may be in operative communication with each other, such as through wireless networks, cell networks, radio frequencies, wired, or other communication methods.

At any point during operation, one or more faults or anomalies may occur (e.g., while navigating to the delivery location, while delivering the payload, while returning from the delivery location, etc.). Such faults may include, without limitation, component or system failure, mechanical failure, electrical failure, communications failure, sensor failure, etc. Upon detection of a fault, a system level response for the aerial vehicles may be determined. In examples, a fault detection may drive an analysis of system capabilities. Based on available system capabilities, a system level response may occur. For example, if a capability is compromised, a first system level response may occur. If a certain set of capabilities are compromised, a second system level response may occur (e.g., different than the first system level response). In various examples, the system may be configured to assess capabilities of the vehicle overall and the impact of a particular fault on the performance of the vehicle, e.g., whether the vehicle can continue its current mission or whether a particular response protocol (e.g., for recovery and/or emergency) should be activated.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

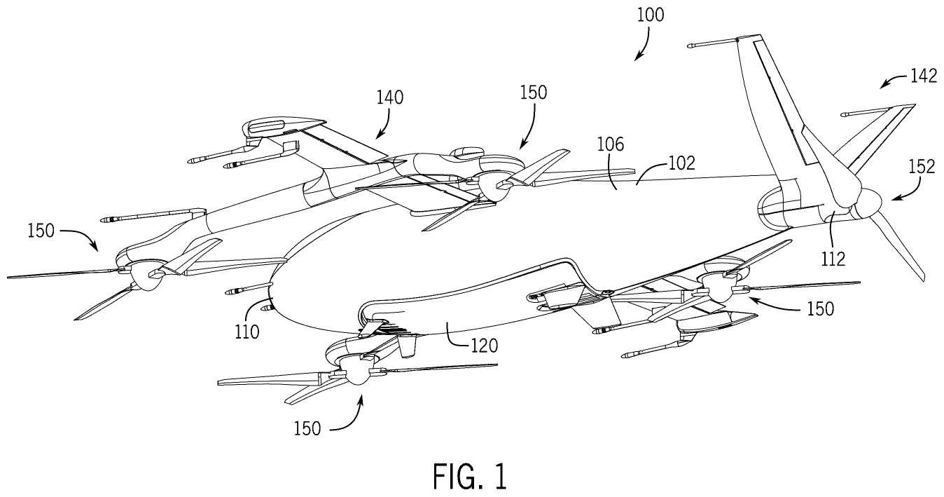

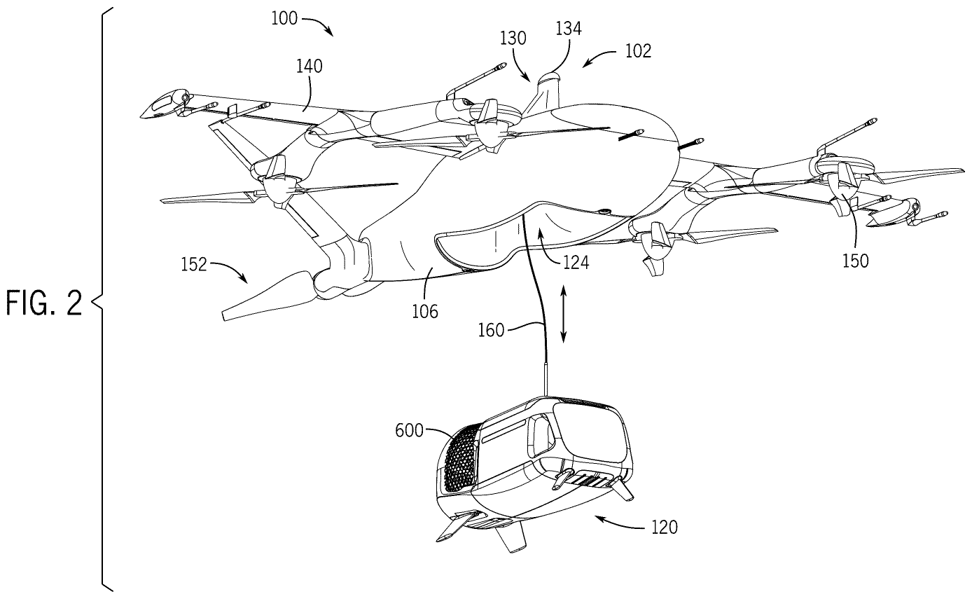

FIGS. 1-2 illustrate an example UAV 100 or aerial vehicle delivery system. The UAV 100 includes various components and systems enabling aerial delivery of a payload, such as packages, food, or other items, to a delivery location. For example, the UAV 100 may be configured for flights over a distance, such as from a pickup location to the delivery location, while carrying or retaining a payload for delivery. At a desired location, such as at the delivery location, the UAV 100 may deliver the payload, such as through deployment of a portion of the UAV 100, as described herein.

The UAV 100 may include a first or primary aerial vehicle 102 (hereinafter “first aerial vehicle”). The first aerial vehicle 102 may include a fuselage 106 that defines a housing or body for the first aerial vehicle 102. The fuselage 106 may include a nose 110 portion forming a front end of the first aerial vehicle 102 and a tail 112 portion forming a rear end of the first aerial vehicle 102. The fuselage 106 may generally taper as it extends towards both the tail 112 and the nose 110, although in other configurations, the fuselage 106 may be differently configured. The fuselage 106 may be configured to store various components of the first aerial vehicle 102, such as a payload and/or a second or secondary aerial vehicle 120 (hereinafter “second aerial vehicle”). For example, a vehicle compartment 124 may be defined as a cavity within the fuselage 106, such as on a bottom surface of the fuselage 106, to receive the second aerial vehicle 120 therein. The fuselage 106 (and/or other components of the first aerial vehicle 102) may be configured to include aesthetically pleasing features and elements.

The first aerial vehicle 102 may include one or more sensors that collect data to assist in the operation of the first aerial vehicle 102. For example, the first aerial vehicle 102 may be operated remotely or completely autonomously by detecting information regarding the environment, such as obstacles, weather information, and the like, and may include a computer and/or be in communication with a processor, to allow the first aerial vehicle 102 to make decisions regarding flight, docking, and landing. With respect to docking, the first aerial vehicle 102 may include a docking assembly 130. The docking assembly 130 may include various structure (e.g., a fin 134 or other structure) to be received or partially inserted within a dock for the first aerial vehicle 102, as described below.

The first aerial vehicle 102 may include a wing assembly 140 and a tail wing assembly 142. The wing assembly 140 may include multiple wings coupled to the fuselage 106 (e.g., a pair of wings extending from opposite sides of the fuselage 106). The wings may be fixed in position relative to the fuselage 106 and configured to enable a cruise or forward flight motion of the first aerial vehicle 102. The tail wing assembly 142 may extend from or be otherwise coupled to the tail 112. The tail wing assembly 142 may function as a stabilizer for the first aerial vehicle 102 to help stabilize the first aerial vehicle 102 during flight. In one example, the tail wing assembly 142 may be arranged in a V-structure to provide both horizontal and vertical stabilization, but in other embodiments may be differently configured.

The first aerial vehicle 102 may include one or more propulsion systems (e.g., propeller assemblies) to both propel the first aerial vehicle 102 in a first flight motion (e.g., forward flight) as well as a second flight motion, such as a hover position and/or multi-dimensional flight. In one example, the first aerial vehicle 102 may include a main propeller assembly 150. The main propeller assembly 150 may include multiple propeller assemblies, with the propeller assemblies coupled to booms or otherwise configured to be positioned spaced apart from the fuselage 106. A rear or tail propeller assembly 152 may be coupled to the fuselage 106, such as to the tail 112. The tail propeller assembly 152 may propel the first aerial vehicle 102 in forward flight and/or hover or multidimensional flight. For example, the tail propeller assembly 152 may be articulable or movable based on the desired flight for the first aerial vehicle 102.

Other examples of the first aerial vehicle 102 may be found in International Patent Application No. PCT/US2024/014632, filed on Feb. 28, 2024, and titled “Aerial Vehicle and Aerial Vehicle Systems,” the disclosure of which is hereby incorporated by reference in its entirety.

The second aerial vehicle 120 may be selectively attached to and/or stored within the first aerial vehicle 102 during flight to or from the delivery location. In such examples, the first aerial vehicle 102 provides propulsion for flights over a distance, such as from a pickup location to the delivery location. During such flight, the second aerial vehicle 120 may be attached to, partially inside, nested, or otherwise stored within the first aerial vehicle 102 in a retracted or stowed position. At a desired location, such as at the delivery location, the second aerial vehicle 120 may be deployed from the first aerial vehicle 102 to deliver a payload.

At the delivery location, the propulsion system of the first aerial vehicle 102 may enable hovering flight over the delivery location at a first altitude or height above the delivery location (e.g., may include cruise and hover propellers). The second aerial vehicle 120 may be deployed from the first aerial vehicle 102 at the first altitude to the delivery location. For example, the second aerial vehicle 120 may be released and allowed (e.g., using gravitational force) to descend downwards from the first aerial vehicle 102. After delivery, the second aerial vehicle 120 may be retracted back into the first aerial vehicle 102. Both the descent and the ascent may be controlled by a retraction assembly (e.g., a tether 160) or another mechanism.

The second aerial vehicle 120 may nest in the vehicle compartment 124. The nesting may result in a more secure stowing of the second aerial vehicle 120. When the second aerial vehicle 120 is stowed in the first aerial vehicle 102, the bottom surface of the second aerial vehicle 120 may align with the bottom surface of the first aerial vehicle 102 to define a single bottom surface. When stowed, the second aerial vehicle 120 may provide additional stability or assist in balancing the first aerial vehicle 102 during forward flight. For example, the vehicle compartment 124 may be defined around a center of gravity of the first aerial vehicle 102. When stowed, a center of gravity of the second aerial vehicle 120 may be positioned to correspond with the center of gravity of the first aerial vehicle 102.

The second aerial vehicle 120 may include one or more propulsion assemblies 600 to maneuver the second aerial vehicle 120 relative to the first aerial vehicle 102. In one example, the propulsion assemblies 600 are arranged to provide forward and/or side-to-side movement of the second aerial vehicle 120, or rotation of the second aerial vehicle 120 about the tether 160.

Either or both of the first aerial vehicle 102 or the second aerial vehicle 120 may include one or more processing elements and/or sensors to load/deliver a package and/or to traverse a flight path from the pickup location to the delivery location, to the pickup location or a service station, or to a designated or predetermined site. The first aerial vehicle 102 or the second aerial vehicle 120 may be autonomous, partially autonomous, or navigated by a user from a controlling location. The UAV 100 may operate in rural or urban locations. Accordingly, the first aerial vehicle 102 may deploy the second aerial vehicle 120 in a variety of locations and environmental conditions.

Either or both of the pickup location or the delivery location may be a warehouse, restaurant, retail store, service center, residential building or a similar location where delivery services may be utilized. A delivery recipient may designate the delivery location as a specific portion of a building or area, such as a door, a window, a deck, a roof, a parking area, or other locations accessible by a delivery recipient.

Other examples of the second aerial vehicle 120 may be found in International Patent Application No. PCT/US2024/018347, filed on Mar. 4, 2024, and titled “Autonomous Delivery Vehicle and System,” the disclosure of which is hereby incorporated by reference in its entirety.

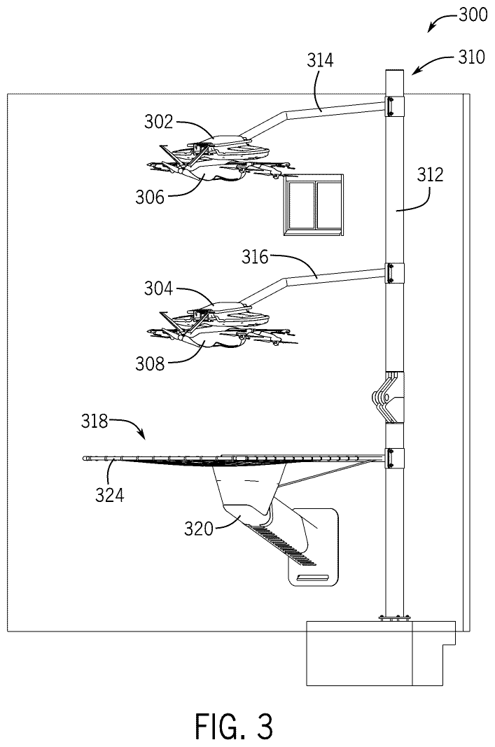

FIG. 3 illustrates an example docking system 300 for one or more aerial vehicles (e.g., the UAV 100). The docking system 300 may include at least one dock 302, but may include more than one dock, such as docks 302 and 304 that mechanically retain UAVs 306 and 308, respectively (e.g., secure the UAVs in a docked configuration). In examples, the docks 302 and 304 may provide electrical connections (e.g., power and/or data) to the UAVs 306 and 308 to, for example, charge batteries of the UAVs 306 and 308 and/or provide mission information or other useful data to the UAVs 306 and 308. Each of UAV 306 and UAV 308 may be similar to the UAV 100, described above. To secure each UAV 306 or 308 to a dock 302 or 304, the docking assembly 130 of the first aerial vehicle 102 may be latched to the dock 302 or 304.

The docks 302 and 304 may be mounted on or otherwise held in place by a support 310. The support 310 may include a vertical tower 312 and arms 314 and 316. When held in place by the support 310, the docks 302 and 304 are generally positioned to receive UAVs 306 and 308. Although FIG. 3 is discussed with respect to two docks, in other instances, fewer (e.g., a single dock) or more than two docks may be coupled to the tower 312 or other support structure that supports the docks relative to the ground or other support surface and/or building.

In various examples, each dock 302 and 304 may be configured to charge a UAV and/or may be configured to allow a UAV to unload and/or receive payload via a loading assembly 318. For example, dock 302 may be a charging dock, such that UAV 306 may receive electrical power (e.g., to charge batteries) via the dock 302. Dock 304 may be a loading dock, which may or may not provide charging capabilities to UAV 308. However, the dock 304 is generally placed relative to the loading assembly 318 such that the UAV 308 may utilize the loading assembly 318 to receive and/or deliver payload. For example, the second aerial vehicle 120 may descend from the first aerial vehicle 102 and pass through a chute 320 (or passage, tube, ramp) of the loading assembly 318 to deliver payload to, and/or receive payload from, the inside of the building adjacent to the docking system 300. In examples, the docking system 300 may include a barrier 324. The barrier 324 may be a platform or net placed around an opening to the chute 320.

In various examples, docking assemblies may include different numbers of charging and/or loading docks, multiple towers, and the like. Other examples of the docking system 300 may be found in International Patent Application No. PCT/US2024/016087, filed on Feb. 16, 2024, and titled “Docking Configurations for Aerial Vehicles,” the disclosure of which is hereby incorporated by reference in its entirety.

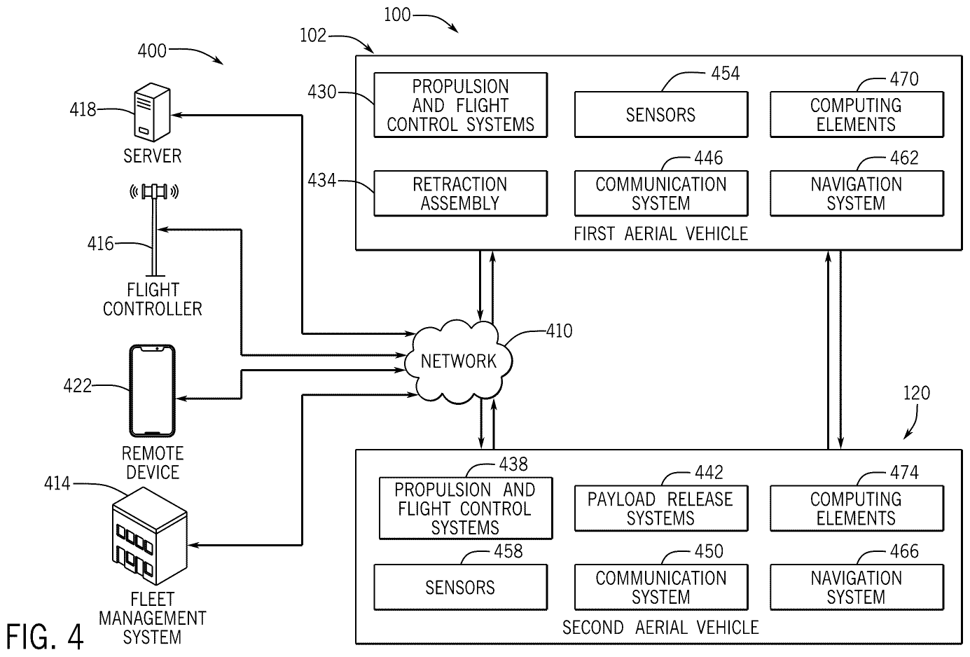

FIG. 4 illustrates a schematic diagram of an example aerial vehicle system 400. The aerial vehicle system 400 may include the UAV 100, such as the first aerial vehicle 102 and the second aerial vehicle 120. The aerial vehicle system 400 may include a network 410 through which the one or more devices of the aerial vehicle system 400 may communicate. The devices or components of the aerial vehicle system 400 may be communicatively or operatively coupled with each other, or one or more computing systems to enable autonomous operation or navigation of the first aerial vehicle 102 and/or the second aerial vehicle 120.

The aerial vehicle system 400 may include a fleet management system 414 in operative communication with the UAV 100, such as the first aerial vehicle 102 and/or the second aerial vehicle 120. In examples, the fleet management system 414 may organize the distribution of UAVs in a location. For example, the fleet management system 414 may receive delivery requests and identify one or more UAVs to fulfill the delivery requests. Accordingly, the fleet management system 414 may issue commands to the first aerial vehicle 102 and/or the second aerial vehicle 120, or other devices of aerial vehicle system 400, to begin operation.

The aerial vehicle system 400 may include a flight controller 416. The flight controller 416 may generate or update flight paths for the UAV 100. For example, the flight controller 416 may determine flight paths between two or more locations, such as between a shipper or retail location and a delivery location. In examples, the flight controller 416 may determine all aspects of the flight path. In other examples, the flight controller 416 may determine portions of the flight path, such as the start and end points or corridors open for travel by the UAV 100. In such examples, the UAV 100 (e.g., the first aerial vehicle 102 and/or the second aerial vehicle 120) may determine the remaining portions of the flight path. In some examples, the flight controller 416 may determine a portion of the maneuvers for the UAV 100 to navigate a flight path.

The aerial vehicle system 400 may include a server 418 including one or more databases or for executing one or more computing operations. The server 418 may be a computing system including one or more processing elements for storing information or executing one or more operations of the aerial vehicle system 400. For example, the server 418 may include a database of relevant information for flight, such as weather, map data, information on a delivery environment or delivery location, or the like. In examples, as described herein, machine learned models may be used by the system for autonomous or partially autonomous navigation of the UAV 100, including the first aerial vehicle 102 and/or the second aerial vehicle 120. The machine learned models or the training data for the models may be located at or executed by the server 418.

The aerial vehicle system 400 may include or be in communication with a remote device 422. The remote device 422 may be a user device or an operator device. As an operator device, the remote device 422 may receive information from the aerial vehicle system 400 or inputs and commands for communication to the aerial vehicle system 400. For example, an operator may use the remote device 422 to resolve conflicts in the aerial vehicle system 400, correct or update flight paths, or the like. As a user device, the remote device 422 may generate delivery requests to the aerial vehicle system 400 or provide other inputs to the aerial vehicle system 400. The delivery requests may identify payloads for delivery, or locations to receive and/or deliver payloads. The delivery requests may also include information relating to the delivery, such as time to deliver, pickup locations, delivery locations, or the like.

While reference is made to single and separate devices herein, it is appreciated that multiples of the same device may be included, such as multiple aerial vehicles, multiple servers 418, or multiple flight controllers 416, and the like. Similarly, the various devices, such as the flight controller 416, remote device 422, server 418, or fleet management system 414 may be a single device or unit or may be multiple devices which may be distributed at one or more physical or virtual locations.

The first aerial vehicle 102 may include propulsion and flight control systems 430. The propulsion and flight control systems 430 may include the propulsion systems/assemblies described above, such as the main propeller assembly 150 and the tail propeller assembly 152, or other features related to the flight or physical control of the first aerial vehicle 102. The first aerial vehicle 102 may include a retraction assembly 434 for selectively deploying and retracting the second aerial vehicle 120. The retraction assembly 434 may include tether 160 and a selective locking mechanism, or other features related to coupling or controlling the second aerial vehicle 120 by the first aerial vehicle 102, as described above or in International Patent Application No. PCT/US2024/014632 or International Patent Application No. PCT/US2024/018347, incorporated by reference herein.

The second aerial vehicle 120 may include propulsion and flight control systems 438 for independent movement of the second aerial vehicle 120 relative to the first aerial vehicle 102, such as to navigate the second aerial vehicle 120 to a payload location. The propulsion and flight control systems 438 may include the propulsion systems/assemblies described above, such as the propulsion assemblies 600, or other features related to the flight or physical control of the second aerial vehicle 120. The second aerial vehicle 120 may include payload release systems 442 providing the selective storage and release of payloads for deliveries.

Either or both of the first aerial vehicle 102 and the second aerial vehicle 120 may include communication systems 446, 450 for transferring information between the first aerial vehicle 102 and the second aerial vehicle 120, and/or to one or more of the devices of aerial vehicle system 400. The communication systems 446, 450 may be wired and/or wireless systems. For example, the first and second aerial vehicles 102, 120 may communicate over short or long ranges. In some examples, the first and second aerial vehicles 102, 120 may communicate by Bluetooth, Wi-Fi, cellular communication, satellite, or the like, without intent to limit.

Either or both of the first aerial vehicle 102 and the second aerial vehicle 120 may include sensors or sensor assemblies 454, 458, such as those described herein. The sensors 454, 458 may include audio sensors and/or visual sensors. The sensors 454, 458 may also include various sensors that detect or determine force, orientation, acceleration, location, elevation, temperature, and/or similar characteristics of the first aerial vehicle 102, the second aerial vehicle 120, and/or the delivery environment.

Either or both of the first aerial vehicle 102 and the second aerial vehicle 120 may include navigation systems 462, 466. The navigations systems 462, 466 may determine locations, orientations, or movements of the first aerial vehicle 102 and/or the second aerial vehicle 120.

For example, navigation system 462 may be in communication with sensors 454 and/or 458 to determine the location or heading of the first aerial vehicle 102 and/or the second aerial vehicle 120. Similarly, navigation system 466 may be in communication with sensors 454 and/or 458 to determine the location or heading of the second aerial vehicle 120 and/or the first aerial vehicle 102. The navigations systems 462, 466 may be in communication with global satellite systems (e.g. GPS or GNSS) to determine delivery locations, conformity with flight paths, or the like.

Either or both of the first aerial vehicle 102 and the second aerial vehicle 120 may include computing elements or resources 470, 474. The computing elements 470, 474 may include one or more processors configured to receive information (such as from on-board and/or off-board sensors) and make decisions based on the information, such as directing the first aerial vehicle 102 and/or the second aerial vehicle 120 to fly to certain locations or the like. The computing element may be operatively or communicatively coupled with the communication systems 446, 450, which may allow the computing elements 470, 474 to receive information from off-board sources, such as the flight controller 416, fleet management system 414, server 418, remote device 422, or other devices of aerial vehicle system 400. In examples, the computing elements 470, 474 may be operatively or communicatively coupled with the sensors 454, 458. The computing elements 470, 474 may interpret information gathered by the sensors 454, 458, such as to identify objects, features, or other characteristics of the surroundings. In examples, the computing elements 470, 474 may interpret the information gathered by the sensors 454, 458 to determine a flight path of the first aerial vehicle 102 and/or the second aerial vehicle 120.

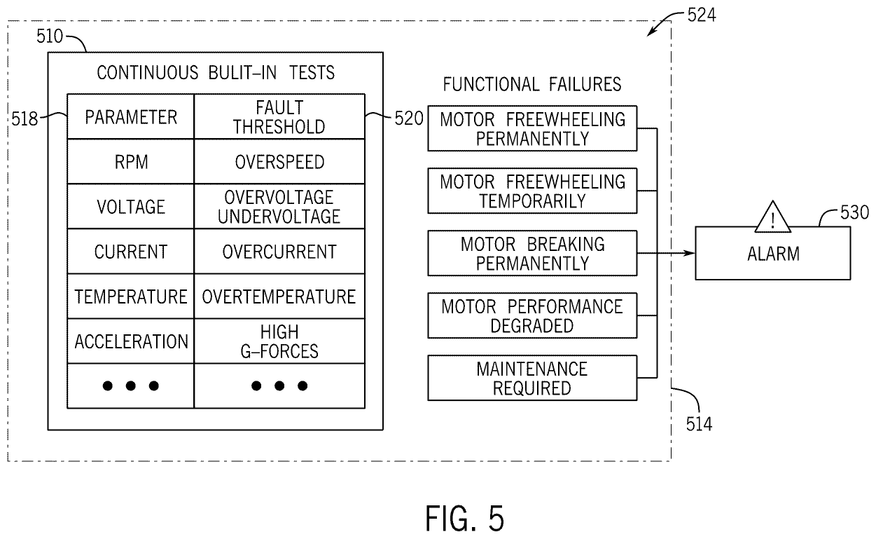

FIG. 5 illustrates a diagram of determining a functional failure of a UAV (e.g., any of the UAVs or aerial vehicles described herein). For example, one or more faults may occur during operation of UAV 100. Such faults may include component or system failure, communication failure, or threshold failure, among other failure modes, whether complete or partial. The failure modes may be detectable (e.g., by the UAV 100), such as based on continuous built-in tests 510 as part of a fault management system or strategy. The fault management system or strategy may identify potential faults of a component or system, such as faults that occur more frequently than others (e.g., based on historical experience), faults causing operational effects of the UAV 100 (e.g., based on failure mode and effect analysis), and the like. The fault management system or strategy may process the detectable faults, including associating sensor measurements to faults and determining a system level response based on the detected fault. In examples, the fault management system or strategy may prioritize a response based on a severity of the detected fault(s), as described below. The severity may be based on the impact to the capabilities of the UAV 100 and not necessarily the severity of the failure itself. For example, a component (e.g., sensor) could have a catastrophic failure, but the failure of the component itself may not be severe to the capabilities of the UAV 100 or the overall system as a hole (e.g., because of Docket redundancies, because vehicle capabilities are not impacted by the loss of the particular component, etc.).

In examples, one or more relationships may exist between detected faults and their functional effects on the UAV 100. For example, a detected fault may indicate a component or system is about to fail or has failed completely. In such examples, the functional effects of the detected fault may vary. For example, the associated component or system may still function with a partial or predicted failure, with the component or system being inoperable only with complete failure. In such examples, the fault management system or strategy may identify failures or faults that lead to a capability/function review and response, as detailed below. For instance, the system may include a library of capabilities and a library of system level responses based on failed capabilities. In this manner, the fault management system or strategy may focus on vehicle capabilities, rather than component failures in isolation.

Along these lines, FIG. 5 illustrates component fault handling that leverages associated vehicle capabilities to reduce complexity by reporting functional, rather than component, failures. As shown, continuous built-in tests 510 may query one or more parameters within a component or system boundary 514. In this manner, the interpretation of a fault may be kept within the component or system itself (e.g., closest to sensors or processors with full set of information). FIG. 5 illustrates example parameters 518 of the continuous built-in tests 510, including, without limitation, motor speed (e.g., revolutions per minute (RPM)), voltage, current, temperature, and acceleration. FIG. 5 also illustrates associated fault thresholds 520 of each parameter 518, including, without limitation, overspeed, overvoltage and undervoltage, overcurrent, overtemperature, and high G-forces. In addition to a detected parameter fault, the fault management system may react to the absence of information. For instance, if a component or system does not report a healthy or unhealthy status, the component or system may be treated as if it is unhealthy (e.g., a functional failure is associated with the component or system).

FIG. 5 illustrates functional failures 524 associated with detected fault thresholds. Example functional failures 524 include, without limitation, permanent motor freewheeling, temporary motor freewheeling, permanent motor braking, degraded motor performance, and required maintenance. Such functional failures 524 are illustrative with respect to the fault threshold examples of FIG. 5, and other configurations are contemplated. One or more functional failures 524 may be associated with a fault threshold. For example, a fault threshold of detected high G-forces may indicate required maintenance and/or permanent motor braking, among other functional failures 524.

Based on the detected functional failure(s) 524, an alarm 530 may be generated. The alarm 530 may summarize the functional failure(s) 524. In examples, the alarm 530 may be sent to one or more devices or processing units, such as to any device of aerial vehicle system 400 via communication systems 446, 450 and/or network 410. The alarm 530 may be an actual alarm or a control signal for the UAV 100, the aerial vehicle system 400, or another system to analyze. For example, the alarm 530 may be a notification to a mission control (e.g., fleet management system 414).

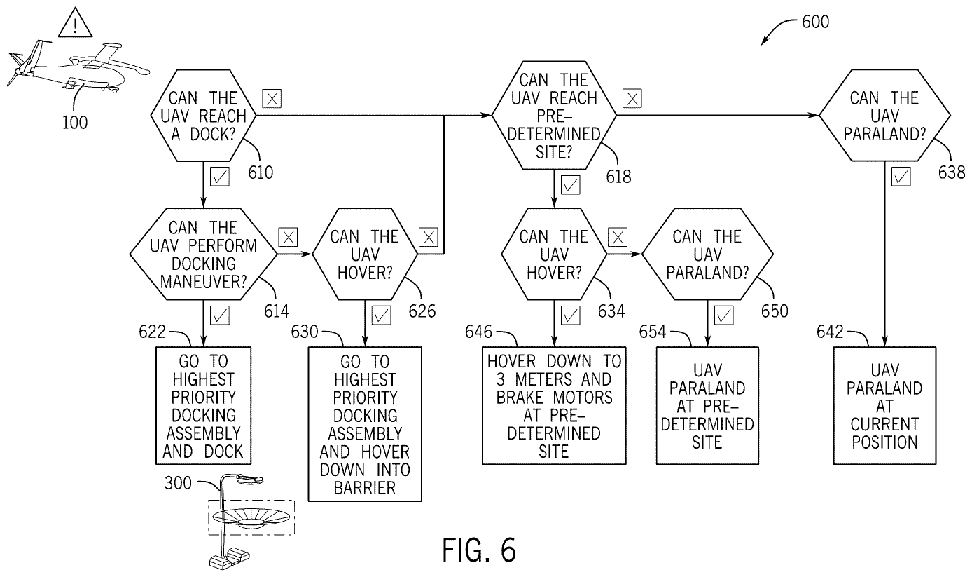

FIG. 6 illustrates a diagram of determining a system level response of a UAV based on a combination of failed UAV capabilities. For example, based on a detected failure or compromised capability during operation or transit of UAV 100 (e.g., any of functional failures 524), the UAV 100, the aerial vehicle system 400, or another system or component (hereinafter “system” to include any and all variations), may determine an appropriate system level response to the detected failure or compromised capability. The determination may be based on whether the UAV 100 can perform certain maneuvers or capabilities. For example, the system may assess capabilities of the UAV 100 in relation to continuing or completing its current mission, and in response, determining tiered maneuvers based on remaining capabilities. As such, rather than simply registering a failure, the system may provide a tiered assessment about whether the failure should require immediate remediation or action (e.g., maintenance) in the future (e.g., after completing a mission). Along these lines, conventional systems may immediately shut down based on a detected component or system failure, without performing a holistic assessment of how the failure impacts the ability to complete a mission, as described herein.

Turning to the example of FIG. 6 specifically, in block 610, the system may determine whether the UAV 100 can perform a first function or capability, such as reaching a dock (e.g., dock 302 or 304 described above).

If block 610 determines that the UAV 100 can reach a dock, the system may determine, in block 614, whether the UAV 100 can perform a second function or capability, such as a docking maneuver. If block 610 determines that the UAV 100 cannot reach a dock, the system may determine, in block 618, whether the UAV 100 can perform a third function or capability, such as reaching a predetermined site (e.g., a predetermined landing area, a home base, etc.).

If block 614 determines that the UAV 100 can perform a docking maneuver, the system may determine or direct a first system level response 622. The first system level response 622 may be a tier 1 response of the UAV 100. As one example, the first system level response 622 may include docking the UAV 100. For example, the first system level response 622 may include sending the UAV 100 to, and docking the UAV 100 at, the highest priority docking system 300. If block 614 determines that the UAV 100 cannot perform a docking maneuver, the system may determine, in block 626, whether the UAV 100 can perform a fourth function or capability, such as hovering.

If block 626 determines that the UAV 100 can hover, the system may determine or direct a second system level response 630. The second system level response 630 may be a tier 2 response of the UAV 100. As one example, the second system level response 630 may include hovering the UAV 100 down for landing at the docking system 300. In examples, the second system level response 630 may include sending the UAV 100 to the highest priority docking system 300 and hovering down into the barrier 324. If block 626 determines that the UAV 100 cannot hover, the system may proceed to block 618.

If block 618 determines that the UAV 100 can reach a predetermined site, the system may determine, in block 634, whether the UAV 100 can perform a fifth function or capability, such as hovering. If block 618 determines that the UAV 100 cannot reach a predetermined site, the system may determine, in block 638, whether the UAV 100 can perform a sixth function or capability, such as paralanding (e.g., via a parachute). If block 638 determines that the UAV 100 can paraland, the system may determine or direct a third system level response 642. The third system level response 642 may be a tier 3 response of the UAV 100. As one example, the third system level response 642 may include paralanding the UAV 100 at the current location.

If block 634 determines that the UAV 100 can hover, the system may determine or direct a fourth system level response 646. The fourth system level response 646 may be a tier 4 response of the UAV 100. As one example, the fourth system level response 646 may include hovering the UAV 100 down for landing at the predetermined site. In examples, the fourth system level response 646 may include hovering the UAV 100 down (e.g., to approximately 3 meters) and braking the motors for landing at the predetermined site. If block 634 determines that the UAV 100 cannot hover, the system may determine, in block 650, whether the UAV 100 can perform a seventh function or capability, such as paralanding (e.g., via a parachute).

In block 650 determines that the UAV 100 can paraland, the system may determine or direct a fifth system level response 654. The fifth system level response 654 may be tier 5 response of the UAV 100. As one example, the fifth system level response 654 may include paralanding the UAV 100 at the predetermined site.

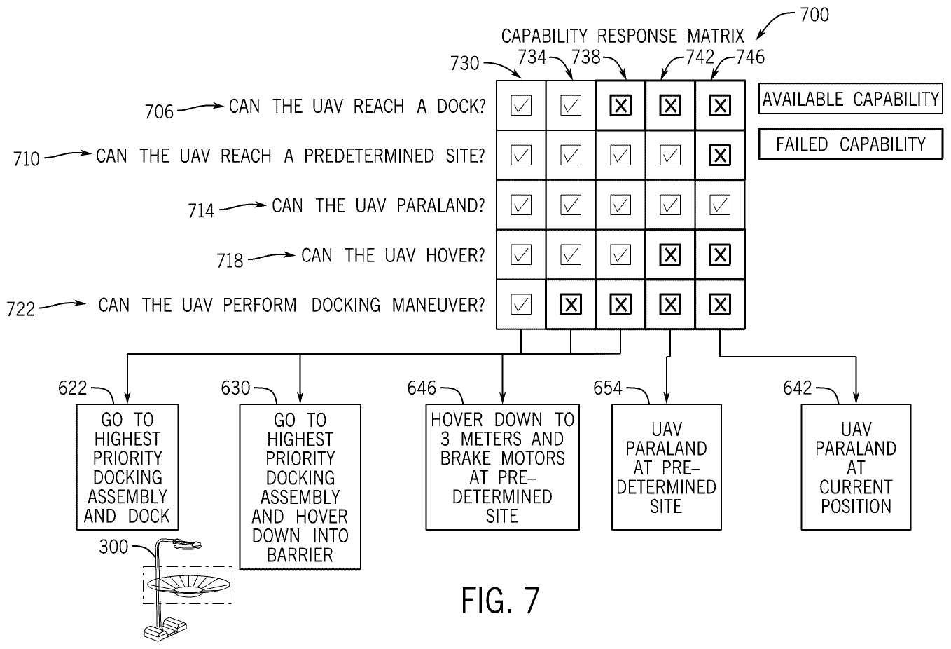

FIG. 7 illustrates a diagram of a capability response matrix 700. The capability response matrix 700 may map available capabilities to a system level response, such as the least severe response. The capability response matrix 700 may include a first capability 706, a second capability 710, a third capability 714, a fourth capability 718, and a fifth capability 722, or any combination thereof. The first capability 706 may be associated with block 610, described above (e.g., “Can the UAV reach a Dock?”). The second capability 710 may be associated with block 618, described above (e.g., “Can the UAV Reach a Predetermined Site?”). The third capability 714 may be associated with block 638 or block 650, described above (e.g., “Can the UAV Paraland?”). The fourth capability 718 may be associated with block 626 or block 634, described above (e.g., “Can the UAV Hover?”). The fifth capability 722 may be associated with block 614, described above (e.g., “Can the UAV Perform a Docking Maneuver?”). Such examples are non-limiting, and the capability response matrix 700 may include other or different capabilities of the UAV 100.

The capability response matrix 700 may include various combinations of available and failed capabilities. For example, each column of the capability response matrix 700 may represent different combination of available and failed capabilities. Particularly, as shown in FIG. 7, a first column 730 may represent a first combination of available and failed capabilities, a second column 734 may represent a second combination of available and failed capabilities, a third column 738 may represent a third combination of available and failed capabilities, a fourth column 742 may represent a fourth combination of available and failed capabilities, and a fifth column 746 may represent a fifth combination of available and failed capabilities. In the first column 730, all capabilities may be available. In the second column 734, the fifth capability 722 may be a failed capability. In the third column 738, both the first capability 706 and the fifth capability 722 may be failed capabilities. In the fourth column 742, the first capability 706, the fourth capability 718, and the fifth capability 722 may be failed capabilities. In the fifth column 746, only the third capability 714 may be available.

One or more system level responses may be mapped to the capability response matrix 700. For example, the first system level response 622, the second system level response 630, and the fourth system level response 646 may be mapped to each of the first combination of capabilities of the first column 730, the second combination of capabilities of the second column 734, and the third combination of capabilities of the third column 738. The fifth system level response 654 may be mapped to the fourth combination of capabilities of the fourth column 742. The third system level response 642 may be mapped to the fifth combination of capabilities of the fifth column 746. Such examples are non-limiting, and other configurations are contemplated, such as based on mission context, UAV capabilities, and/or costs. Costs may include UAV costs, recovery costs, and property damage costs, among others. In such examples, one system level response may be prioritized over another system level response based on respective costs of the system level responses (e.g., the system level responses may be tiered based at least on costs).

The system level responses may be set or predetermined per combination of capabilities. In examples, the capability response matrix 700 may be associated with machine learned models, databases, or the like to assist in determining an appropriate system level response. For example, a machine learned model may be trained to suggest, determine, or adjust a response recommendation for a combination of capabilities.

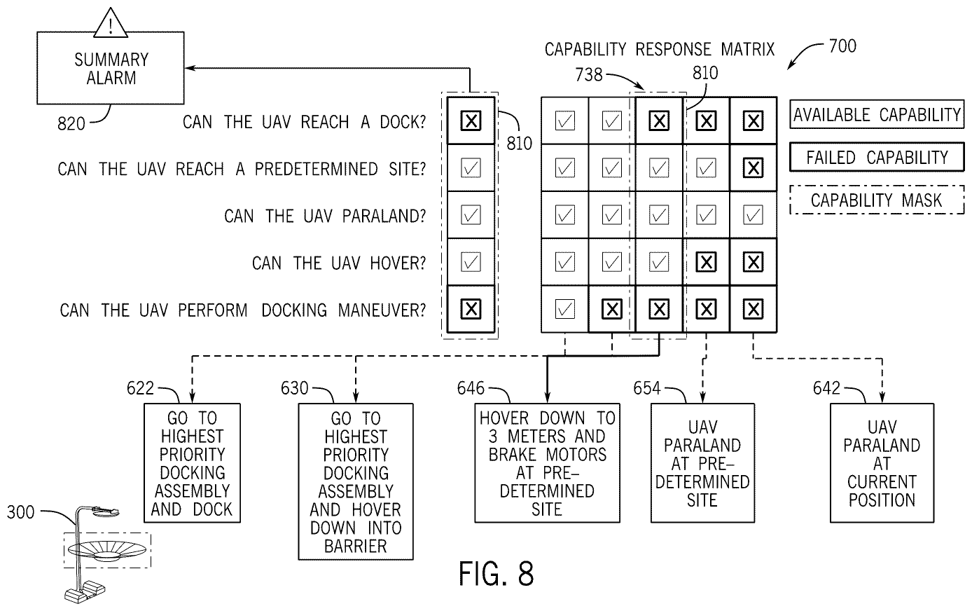

FIG. 8 illustrates a diagram of determining a system level response of a UAV based on the capability response matrix 700. A system level response may be determined based on the column that contains at least all of the failed capabilities of the UAV 100. For example, the column containing at least all of the failed capabilities may define a capability mask 810. The capability mask 810 may be associated with a system level response. For instance, in FIG. 8, the capability mask 810 may be associated with the fourth system level response based on the third combination of available and failed capabilities of the third column 738, although other configurations are contemplated.

With continued reference to FIG. 8, a summary alarm 820 may be generated, such as based on the capability mask 810 of at least all of the failed capabilities. The summary alarm 820 may summarize the failed capabilities of the UAV 100. In examples, the summary alarm 820 may be sent to one or more devices or processing units, such as to any device of aerial vehicle system 400 via communication systems 446, 450 and/or network 410. The summary alarm 820 may be an actual alarm or a control signal for the UAV 100, the aerial vehicle system 400, or another system to analyze. For example, the summary alarm 820 may be notification to a mission control (e.g., fleet management system 414).

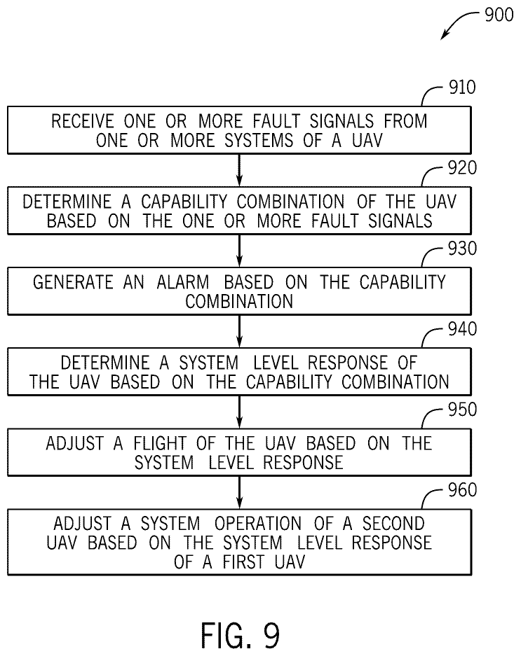

FIG. 9 illustrates a flow chart for an example method 900 of managing a UAV. The UAV may be similar to UAV 100. For example, the UAV may include a first UAV (e.g., the first aerial vehicle 102) and a second UAV (e.g., the second aerial vehicle 120).

At block 910, one or more fault signals may be received from one or more systems of the UAV. For example, one or more fault signals may be received from propulsion and flight control systems 430 and/or 438, retraction assembly 434, payload release systems 442, communication systems 446 and/or 450, sensors 454 and/or 458, navigation systems 462 and/or 466, computing elements 470 and/or 474, or any other component or system of aerial vehicle system 400. The one or more fault signals may be based on system parameters exceeding fault thresholds (e.g., parameters 518 exceeding fault thresholds 520), as described above.

At block 920, a capability combination of the UAV may be determined based on the one or more fault signals. The capability combination may include a combination of one or more of the following capabilities of the UAV: reaching a dock, reaching a predetermined site, paralanding, hovering in place, and performing a docking maneuver. In examples, block 920 may include querying a capability response matrix (e.g., the capability response matrix 700). The capability response matrix may indicate available and failed capabilities of the UAV, such as in a manner described above.

At block 930, an alarm may be generated based on the capability combination. For example, the summary alarm 820 may be generated based on the capability mask 810 of at least all of the failed combinations, as described above. Additionally, or alternatively, the alarm 530 may be generated based on the functional failure(s) 524, as described above.

At block 940, a system level response of the UAV may be determined based on the capability combination. In examples, block 940 may include analyzing the capability combination based on mission characteristics of the UAV. The mission characteristics may include at least one of environmental data, geographic data, or payload data.

At block 950, a flight of the UAV may be adjusted based on the system level response. For example, rather than completing a mission, the UAV may be directed to the nearest docking system 300, paraland, or land at a predetermined site, such as in a manner as described above.

At block 960, a system operation of the second UAV may be adjusted based on the system level response of the first UAV. For example, rather than delivering a payload at a delivery location, the second UAV may remain docked to the first UAV while the first UAV is in a failure mode.

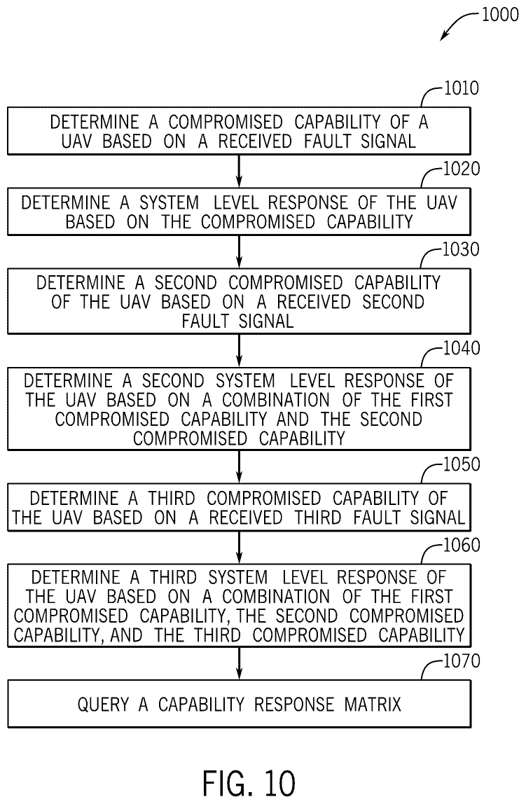

FIG. 10 illustrates a flow chart for another example method 1000 of managing a UAV (e.g., the UAV, the first aerial vehicle 102, the second aerial vehicle 120, etc.). At block 1010, a compromised capability of the UAV may be determined based on a received fault signal. The fault signal may be received from propulsion and flight control systems 430 and/or 438, retraction assembly 434, payload release systems 442, communication systems 446 and/or 450, sensors 454 and/or 458, navigation systems 462 and/or 466, computing elements 470 and/or 474, or any other component or system of aerial vehicle system 400, such as based on system parameters exceeding fault thresholds (e.g., parameters 518 exceeding fault thresholds 520), as described above. The compromised capability may be a first compromised capability.

At block 1020, a system level response of the UAV may be determined based on the compromised capability. For example, the second system level response, described above, may be determined based on the UAV not being able to perform a docking maneuver. The system level response may be a first system level response.

At block 1030, a second compromised capability of the UAV may be determined based on a received second fault signal. The second fault signal may be received from propulsion and flight control systems 430 and/or 438, retraction assembly 434, payload release systems 442, communication systems 446 and/or 450, sensors 454 and/or 458, navigation systems 462 and/or 466, computing elements 470 and/or 474, or any other component or system of aerial vehicle system 400, such as based on system parameters exceeding fault thresholds (e.g., parameters 518 exceeding fault thresholds 520), as described above.

At block 1040, a second system level response of the UAV may be determined based on the combination of the first compromised capability and the second compromised capability. For example, the fourth system level response, described above, may be determined based on the UAV not being able to perform a docking maneuver or reach a dock. The second system level response may be different than the first system level response.

At block 1050, a third compromised capability of the UAV may be determined based on a received third fault signal. The third fault signal may be received from propulsion and flight control systems 430 and/or 438, retraction assembly 434, payload release systems 442, communication systems 446 and/or 450, sensors 454 and/or 458, navigation systems 462 and/or 466, computing elements 470 and/or 474, or any other component or system of aerial vehicle system 400, such as based on system parameters exceeding fault thresholds (e.g., parameters 518 exceeding fault thresholds 520), as described above.

At block 1060, a third system level response of the UAV may be determined based on the combination of the first compromised capability, the second compromised capability, and the third compromised capability. For example, the third system level response or the fifth system level response, described above, may be determined based on the UAV not being able to perform a docking maneuver, reach a dock, or hover. The third system level response may be different than the first system level response and the second system level response.

At block 1070, a capability response matrix (e.g., the capability response matrix 700) may be queried. The capability response matrix may provide the first system level response based on the first compromised capability, such as based on a first combination of available and failed capabilities, as described above. The capability response matrix may provide the second system level response based on the combination of the first compromised capability and the second compromised capability, such as based on a second combination of available and failed capabilities, as described above. The capability response matrix may provide the third system level response based on the combination of the first compromised capability, the second compromised capability, and the third compromised capability, such as based on a third combination of available and failed capabilities, as described above.

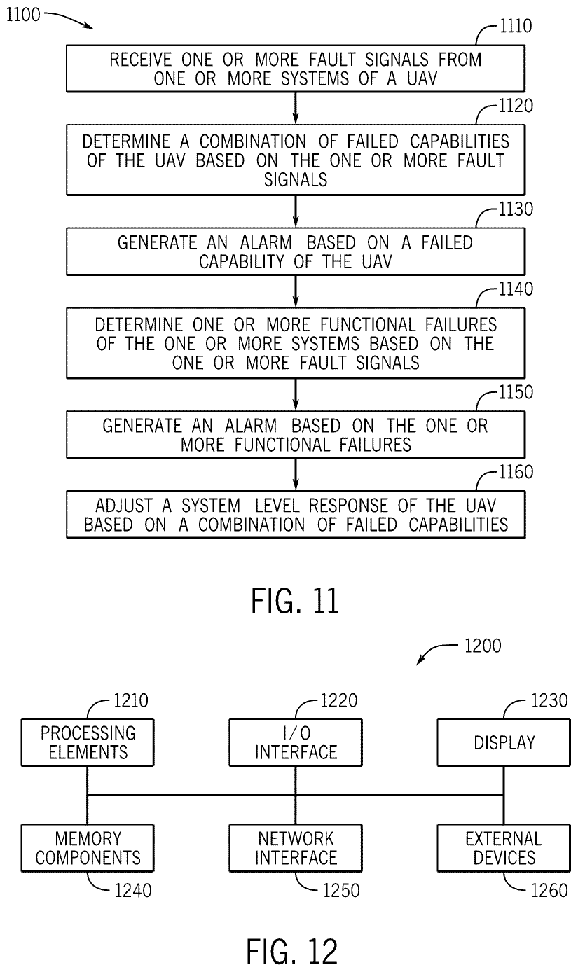

FIG. 11 illustrates a flow chart for another example method 1100 of managing a UAV (e.g., the UAV 100, the first aerial vehicle 102, the second aerial vehicle 120, etc.). At block 1110, one or more fault signals may be received from one or more systems of the UAV. For example, one or more fault signals may be received from propulsion and flight control systems 430 and/or 438, retraction assembly 434, payload release systems 442, communication systems 446 and/or 450, sensors 454 and/or 458, navigation systems 462 and/or 466, computing elements 470 and/or 474, or any other component or system of aerial vehicle system 400. The one or more fault signals may be based on system parameters exceeding fault thresholds (e.g., parameters 518 exceeding fault thresholds 520), as described above.

At block 1120, a combination of failed capabilities of the UAV may be determined based on the one or more fault signals. For example, one or more failed capabilities may be outlined in capability response matrix 700, such as in a manner as described above.

At block 1130, an alarm may be generated based on a failed capability of the UAV. For example, the summary alarm 820 may be generated based on the capability mask 810 of at least all of the failed combinations, as described above.

At block 1140, one or more functional failures of the one or more systems may be determined based on the one or more fault signals, such as in a manner as described above. For example, one or more functional failures 524 may be determined based on detectable parameters 518 exceeding a fault threshold 520. The one or more functional failures may be associated with at least one failed capability of the UAV.

At block 1150, an alarm may be generated based on the one or more functional failures. For example, the alarm 530 may be generated based on the functional failure(s) 524, as described above.

At block 1160, a system level response of the UAV may be adjusted based on the combination of failed capabilities. For example, the UAV may dock, hover, land, or paraland based on additional failed capabilities. Block 1160 may include prioritizing a first system level response over a second system level response based on respective costs of the first system level response and the second system level response. The respective costs may include UAV costs, recovery costs, and property damage costs. In examples, the respective costs may include safety costs, such as air risk, ground risk, and any safety cost associated with not completing a mission (e.g., a delivery mission).

FIG. 12 illustrates a schematic diagram of an example computer system 1200 for implementing various embodiments in the examples described herein. The computer system 1200 may be used to implement the aerial vehicle system 400. For example, the computing elements 470, 474 may include one or more of the components of the computer system 1200.

The computer system 1200 may be used to implement or execute one or more of the components or operations disclosed in FIGS. 1-11, described above. The computer system 1200 may implement any of the methods 900, 1000, or 1100, described above. The computer system 1200 may include one or more processing elements 1210, an input/output interface 1220, a display 1230, one or more memory components 1240, a network interface 1250, and one or more external devices 1260. Each of the various components may be in communication with one another through one or more buses, communication networks, such as wired or wireless networks.

The processing element 1210 may be any type of electronic device capable of processing, receiving, and/or transmitting instructions. For example, the processing element 1210 may be a central processing unit, microprocessor, processor, or microcontroller. Additionally, it should be noted that some components of the computer system 1200 may be controlled by a first processor and other components may be controlled by a second processor, where the first and second processors may or may not be in communication with each other.

The memory components 1240 are used by the computer system 1200 to store instructions for the processing element 1210, as well as store data, such as the trained ML models 1140 and the like. The memory components 1240 may be, for example, magneto-optical storage, read-only memory, random access memory, erasable programmable memory, flash memory, or a combination of one or more types of memory components.

The display 1230 provides visual feedback to a user. Optionally, the display 1230 may act as an input element. The display 1230 may be a liquid crystal display, plasma display, organic light-emitting diode display, and/or other suitable display. In embodiments where the display 1230 is used as an input, the display may include one or more touch or input sensors, such as capacitive touch sensors, a resistive grid, or the like.

The I/O interface 1220 allows a user to enter data into the computer system 1200, as well as provides an input/output for the computer system 1200 to communicate with other devices or services. For example, an I/O interface 1220 may allow a user to provide data, such as for use in navigation of the UAV 100. The I/O interface 1220 can include one or more input buttons, touch pads, and so on.

The network interface 1250 provides communication to and from the computer system 1200. For example, the network interface 1250 may allow communication between the first aerial vehicle 102 and the second aerial vehicle 120, and/or between other devices of the aerial vehicle system 400. The network interface 1250 may include one or more communication protocols, such as, but not limited to WiFi, Ethernet, Bluetooth, and so on. The network interface 1250 may also include one or more hardwired components, such as a Universal Serial Bus (USB) cable, or the like. The configuration of the network interface 1250 depends on the types of communication desired and may be modified to communicate via Wifi, Bluetooth, and so on.

The external devices 1260 may be one or more devices that can be used to provide various inputs to the computer system 1200, e.g., mouse, microphone, keyboard, trackpad, or the like. The external devices 1260 may be local or remote and may vary as desired. In some examples, the external devices 1260 may also include one or more additional sensors.

The technology described herein may be implemented as logical operations and/or modules in one or more systems. The logical operations may be implemented as a sequence of processor implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting.

Changes in detail or structure may be made without departing from the basic elements of the invention as defined in the following claims.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A method of managing an unmanned aerial vehicle (UAV) comprising:
receiving one or more fault signals from one or more systems of the UAV;
determining a capability combination of the UAV based on the one or more fault signals; and
determining a system level response of the UAV based on the capability combination.

2. The method of claim 1, further comprising adjusting a flight of the UAV based on the system level response.

3. The method of claim 1, wherein the capability combination comprises a combination of one or more of the following capabilities of the UAV: reaching a dock, reaching a predetermined site, paralanding, hovering in place, and performing a docking maneuver.

4. The method of claim 1, wherein the determining the capability combination comprises querying a capability response matrix, the capability response matrix indicating available and failed capabilities of the UAV.

5. The method of claim 1, wherein the determining the system level response comprises analyzing the capability combination based on a mission characteristic of the UAV.

6. The method of claim 5, wherein the mission characteristic comprises at least one of environmental data, geographic data, or payload data.

7. The method of claim 1, further comprising generating an alarm based on the capability combination.

8. The method of claim 1, wherein the UAV comprises a first UAV and a second UAV, the method further comprising adjusting a system operation of the second UAV based on the system level response of the first UAV.

9. A method of managing an unmanned aerial vehicle (UAV) comprising:
determining a compromised capability of the UAV based on a received fault signal; and
determining a system level response of the UAV based on the compromised capability.

10. The method of claim 9, further comprising querying a capability response matrix, the capability response matrix providing the system level response based on the compromised capability.

11. The method of claim 9, wherein the compromised capability is a first compromised capability and wherein the system level response is a first system level response, the method further comprising:
determining a second compromised capability of the UAV based on a received second fault signal; and
determining a second system level response of the UAV based on the combination of the first compromised capability and the second compromised capability,
wherein the second system level response is different than the first system level response.

12. The method of claim 11, further comprising querying a capability response matrix, the capability response matrix providing the second system level response based on the combination of the first compromised capability and the second compromised capability.

13. The method of claim 11, further comprising:
determining a third compromised capability of the UAV based on a received third fault signal; and
determining a third system level response of the UAV based on the combination of the first compromised capability, the second compromised capability, and the third compromised capability,
wherein the third system level response is different than the first system level response and the second system level response.

14. The method of claim 13, further comprising querying a capability response matrix, the capability response matrix providing the third system level response based on the combination of the first compromised capability, the second compromised capability, and the third compromised capability.

15. A method of managing an unmanned aerial vehicle (UAV) comprising:
receiving one or more fault signals from one or more systems of the UAV;
determining a combination of failed capabilities of the UAV based on the one or more fault signals; and
adjusting a system level response of the UAV based on the combination of failed capabilities.

16. The method of claim 15, further comprising determining one or more functional failures of the one or more systems based on the one or more fault signals, the one or more functional failures associated with at least one failed capability of the UAV.

17. The method of claim 16, further comprising generating an alarm based on the one or more functional failures.

18. The method of claim 15, wherein the adjusting the system level response comprises prioritizing a first system level response over a second system level response based on respective costs of the first system level response and the second system level response.

19. The method of claim 18, wherein the respective costs comprise safety costs, such as air risk, ground risk, and any safety cost associated with not completing a mission.

20. The method of claim 18, wherein the respective costs comprise UAV costs, recovery costs, and property damage costs.

21. (canceled)
